(19) United States
(12) Patent Application Publication
(10) Pub. No.: US 2016/0259836 A1
(43) Pub. Date: Sep. 8, 2016

(54) PARALLEL ASYNCHRONOUS DATA REPLICATION

(71) Applicant: OVERLAND STORAGE, INC., San Diego, CA (US)

(72) Inventors: Trevor Heathorn, Palo Alto, CA (US); Kevin Osborn, Santa Cruz, CA (US)

(21) Appl. No.: 14/636,606

(22) Filed: Mar. 3, 2015

(51) Int. Cl. G06F 17/30

(52) U.S. Cl. CPC G06F 17/30578; G06F 17/30215

(57) ABSTRACT

A primary data storage system and a secondary data storage system are connected with a mesh of network connections during replication procedures from the primary storage system to the secondary storage system. In some implementations, at the primary storage system, file system metadata is analyzed for different subsets of the primary file system to determine changed and/or potentially changed files and/or directories for each subset. Change information is communicated from the primary storage system for a plurality of the subsets to a secondary storage system in parallel to a plurality of network addresses assigned to network ports of the secondary storage system.

### BACKGROUND

1. Field of the Invention

The present application relates generally to large-scale computer file storage, and more particularly to storage of large numbers of computer files using techniques that provide, reliable, and efficient disk operations on those files.

2. Description of the Related Art

Networking services, such as email, web browsing, gaming, and file transfer are generally provided using a client-server model of communication. According to the client-server model, a server computer provides services to other computers, called clients. Examples of servers include file servers, mail servers, print servers, and web servers. A server communicates with the client computer to send data and perform actions at the client's request. A computer may be both a client and a server.

In an enterprise, it is common to have file servers that deliver data files to client computers. The file servers may include data and hardware redundancy features to protect against failure conditions. Such a server infrastructure may suffer from problems of scalability, as the volume of data that must be processed and stored can grow dramatically as the business grows. Clusters of computers serving as file servers are known in the art. Further improvements in the speed and usability of these systems is desired.

### SUMMARY

In one implementation, a method of replicating data from a primary storage system to a secondary storage system comprises at the primary storage system, analyzing file system metadata for different subsets of the primary file system to determine changed and/or potentially changed files and/or directories for each subset, and communicating change information from the primary storage system for a plurality of the subsets to a secondary storage system in parallel to a plurality of network addresses assigned to network ports of the secondary storage system. The method may include assigning a network address of the plurality of network addresses to each of the different subsets of the primary file system, and may further include using different network ports of the primary storage system to communicate change information for different subsets of the primary file system.

In another implementation, a primary storage system, comprises a set of primary cluster devices storing primary file data comprising a first subset of the primary file data and a second subset of the primary file data, the first subset different than the second subset. A first primary peer set member of a first peer set, the first primary peer set member hosted by a first primary cluster device, the first peer set comprising the first primary peer set member and a first secondary peer set member hosted by a second primary cluster device different than the first primary cluster device. The first primary peer set member may be configured to determine first subset change information characterizing a change to the first subset, communicate the first subset change information to a first network address of a secondary storage system, the secondary storage system storing secondary file data that is a replication of the primary file data. The system may also include a second primary peer set member of a second peer set, the second primary peer set member hosted by the first primary cluster device, the second peer set comprising the second primary peer set member and a second secondary peer set member hosted by the second primary cluster device, the second primary peer set member configured to determine second subset change information characterizing a change to the second subset, and communicate the second subset change information to a second network address of the secondary storage system.

In another implementation, a method comprises determining, using a primary cluster node, first change information for a first subset of primary file data, determining, using the primary cluster node, second change information for a second subset of the primary file data, communicating the first change information from the primary cluster node to a first secondary storage system network address, and communicating the second change information from the primary cluster node to a second secondary storage system network address in parallel with communicating the first change information from the primary cluster node to the first secondary storage system network address.

In another implementation, a method comprises determining first subset change information characterizing a change to a first subset of primary file data using a first primary peer set member of a first peer set, the first primary peer set member hosted by a first primary cluster node of a primary cluster, the primary cluster comprising the first primary cluster node and a second primary cluster node different than the first primary cluster node, the first peer set comprising the first primary peer set member and a first secondary peer set member hosted by the second primary cluster node, the primary file data comprising the first subset and a second subset different than the first subset. The method further includes determining second subset change information characterizing a change to a second subset using a second primary peer set member of a second peer set, the second primary peer set member hosted by the first primary cluster node, the second peer set comprising the second primary peer set member and a second secondary peer set member hosted by the second primary cluster node. The method further comprises communicating the first subset change information to a first secondary cluster node of a secondary cluster, the secondary cluster comprising the first secondary cluster node and a second secondary cluster node different than the first secondary cluster node, the secondary cluster storing secondary file data that is a replication of the primary file data, and communicating the second subset change information to the second secondary cluster node.

In another implementation, a data storage system comprises a primary storage system storing file data organized in a primary file system. The primary storage system comprises a first plurality of network ports. The system also comprises a secondary storage system comprising a second plurality of network ports. The system further comprises a mesh of network connections between the first plurality of network ports and the second plurality of network ports; wherein different branches of the mesh carry replication data traffic associated with file and directory data for different selected subsets of the primary file system. Either one or both of the primary storage system and the secondary storage system may be implemented as clusters of computing devices.

### BRIEF DESCRIPTION OF THE DRAWINGS

The above-mentioned aspects, as well as other features, aspects, and advantages of the present technology will now be described in connection with various embodiments, with reference to the accompanying drawings. The illustrated embodiments, however, are merely examples and are not intended to be limiting. Throughout the drawings, similar symbols typically identify similar components, unless context dictates otherwise. Note that the relative dimensions of the following figures may not be drawn to scale.

FIG. 1 is a network diagram illustrating a data storage and replication system.

FIG. 2 is a network diagram illustrating communication between a primary cluster and a secondary cluster.

FIG. 3 is a conceptual diagram illustrating how file data may be divided into different subsets.

FIG. 4A is an illustration of the content of a peer set.

FIG. 4B is an illustration of some components of file server software at a primary cluster server.

FIG. 5 is a flow chart of a process for asynchronous data replication of a primary cluster.

### DETAILED DESCRIPTION

Various aspects of the novel systems, apparatuses, and methods are described more fully hereinafter with reference to the accompanying drawings. This disclosure may, however, be embodied in many different forms and should not be construed as limited to any specific structure or function presented throughout this disclosure. Rather, these aspects are provided so that this disclosure may be thorough and complete, and may fully convey the scope of the disclosure to those skilled in the art. Based on the teachings herein one skilled in the art should appreciate that the scope of the disclosure is intended to cover any aspect of the novel systems, apparatuses, and methods disclosed herein, whether implemented independently of, or combined with, any other aspect of the invention. For example, an apparatus may be implemented or a method may be practiced using any number of the aspects set forth herein. In addition, the scope of the invention is intended to cover such an apparatus or method which is practiced using other structure, functionality, or structure and functionality in addition to or other than the various aspects of the invention set forth herein. It should be understood that any aspect disclosed herein may be embodied by one or more elements of a claim.

Although particular aspects are described herein, many variations and permutations of these aspects fall within the scope of the disclosure. Although some benefits and advantages of the preferred aspects are mentioned, the scope of the disclosure is not intended to be limited to particular benefits, uses, or objectives. Rather, aspects of the disclosure are intended to be broadly applicable to different wireless technologies, system configurations, networks, and transmission protocols, some of which are illustrated by way of example in the figures and in the following description of the preferred aspects. The detailed description and drawings are merely illustrative of the disclosure rather than limiting, the scope of the disclosure defined by the appended claims and equivalents thereof.

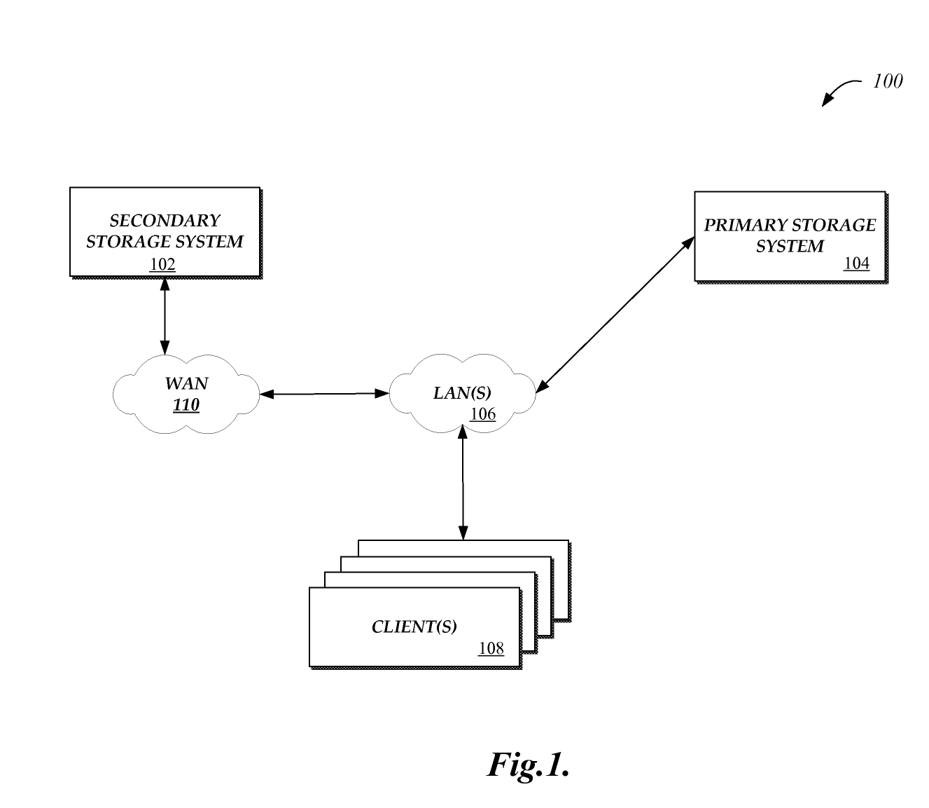

Generally described, aspects of the present disclosure relate to parallel asynchronous data replication between a primary data storage system and a secondary data storage system. In one specific implementation described below, both the primary and secondary systems are implemented as server clusters, wherein each cluster may include multiple computing platforms, each including a combination of processing circuitry, communication circuitry, and least one storage device. In this implementation, each cluster may have file data distributed among the storage devices of the cluster. Server clusters can be advantageous since storage space is efficiently scalable as the storage needs of an enterprise grow. Whether either or both of the primary and secondary systems of FIG. 1 are implemented as single physical servers or as clusters of multiple servers, the secondary storage system maintains secondary file data, which is a replication of primary file data maintained by the primary storage system. The secondary storage system may be, and usually will be, located remotely from the primary system to protect against destruction of and total loss of the primary system due to a fire or other disaster.

FIG. 1 is a network diagram illustrating such a data replication system. The network diagram 100 illustrates one or more clients 108 and a primary storage system 104 connected over at least one Local Area Network (LAN) 106. The network diagram 100 also illustrates a secondary storage system 102 connected to the LAN 106 over a Wide Area Network (WAN) 110, such as the Internet. As discussed above, the primary storage system 104 maintains primary file data and the secondary storage system maintains secondary file data that is a replication of the primary file data. The client(s) 108 may be configured to communicate with the primary storage system 104 for access and/or retrieval of the primary file data maintained by the primary storage system 104. The primary storage system 104 may send change information (e.g. client modified files, folders, directories, etc.) over the WAN 110 (e.g. the Internet) to the secondary storage system 102 so that the secondary storage system may update the secondary file data to replicate changes in the primary file data. In those situations where a primary storage system 104 is already in existence with an established file system and file data, and a secondary storage system 102 is first added to the storage architecture, a copy of the complete content of the primary storage system 104 can be migrated to the secondary storage system 102. Subsequently, as files are modified, added, removed, etc. by client interaction with the primary storage system 104, these changes can be replicated on the secondary storage system 102. The client(s) 108 may have read/write access to the primary file data. Also, the client(s) 108 may have read only access to the secondary file data, at least during replication activity.

As will be explained further below, the replication from the primary storage system 104 to the secondary storage system 102 efficiently utilizes the available bandwidth over the LAN 106 and WAN 110 by providing multiple network ports on both the primary stoage system and the secondary storage system. Replication traffic is distributed across all the network ports on both the primary storage system 104 and the secondary storage system 102.

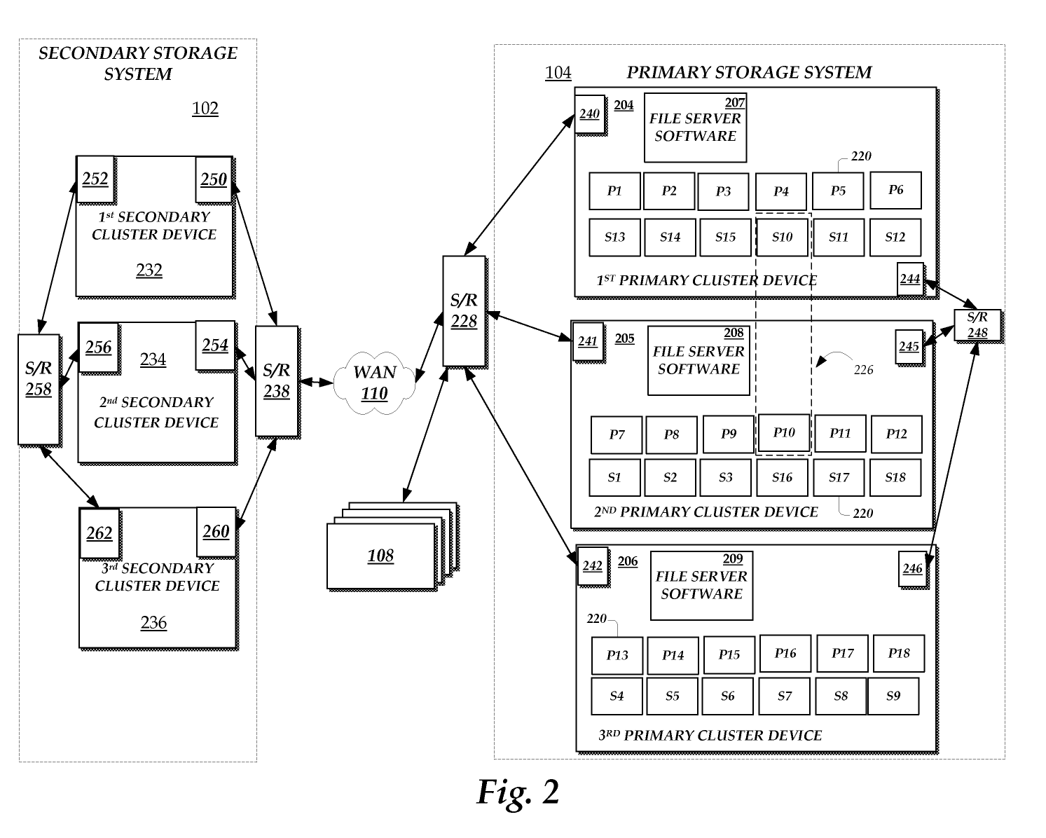

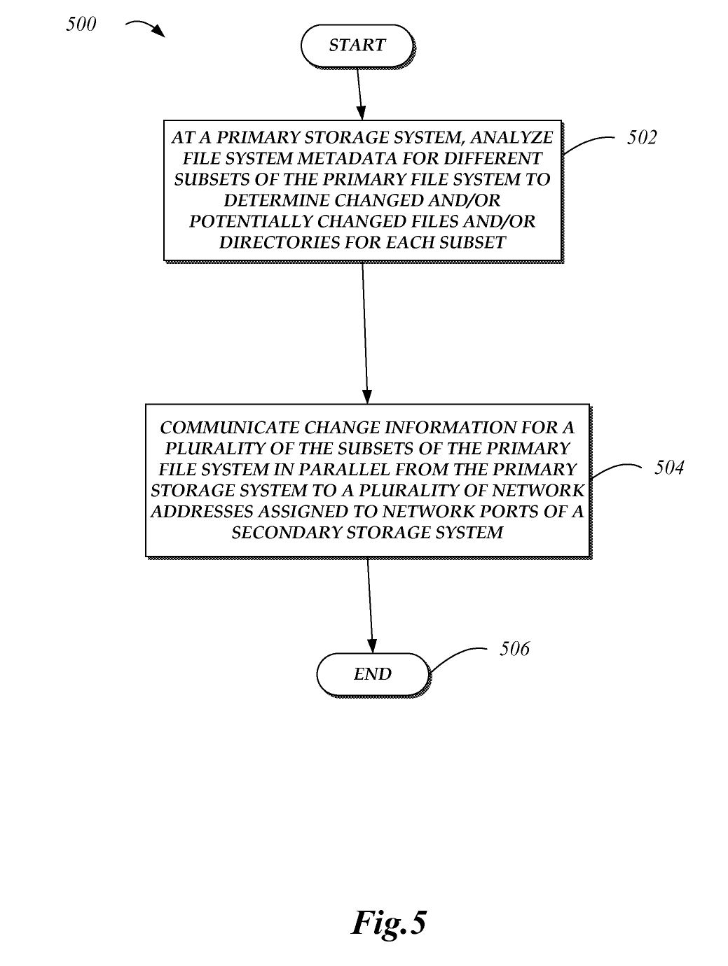

FIG. 2 is a network diagram illustrating the system architecture of FIG. 1 with additional details with regard to one specific possible implementation of such a system. In this implementation, both the primary storage system 104 and the secondary storage system 102 are implemented as clusters of computing devices. As shown in FIG. 2, the primary cluster 104 may include a first primary cluster device 204, a second primary cluster device 205, and a third primary cluster device 206. Although three computing devices are illustrated in the primary cluster 104 of FIG. 2, any number of computing devices may be implemented in a single cluster for different applications in accordance with different embodiments. Each device of the cluster may be referred to as a “node” of the cluster, and the entire cluster may be referred to as a “storage server.” Alternatively, each device of the cluster may be referred to as a “storage server,” since they appear to the clients as servers. In one implementation, the primary cluster devices each include components such as are shown in FIG. 5 of U.S. Pat. No. 8,296,398, entitled Peer-to-Peer Redundant File Server System and Methods. The entire content of U.S. Pat. No. 8,296,398 is incorporated herein by reference in its entirety. Embodiments of such clusters (without the replication features described herein) are available commercially as the SnapScale networked attached storage (NAS) device from Overland Storage, Inc. The SnapScale clusters include three or more servers, each with four or more storage devices.

Referring again to FIG. 2, the first primary cluster device 204 includes a set of storage devices, in this example twelve storage devices, one of which is designated 220 in FIG. 2. Each storage device 220 may be a hard disk drive, for example. The second and third primary cluster devices 205, 206 may also include sets of storage devices, in this case also twelve each, where one of each is also designated 220 in FIG. 2. In the primary cluster 104, the storage devices may be organized into several groups of multiple storage devices each, with each group referred to herein as a “peer set.” Each member of a given peer set is installed in a different device of the cluster. Also, each peer set has a single primary peer set member and at least one secondary peer set member. In FIG. 2, the drive labeled P10 and the drive labeled S10 form the peer set designated 226 that is outlined with a dotted line. In the primary cluster 104 of FIG. 2, P10 is the primary member of peer set 10, and S10 is the secondary member of peer set 10. In the exemplary system of FIG. 2, thirty six storage devices (e.g. hard disk drives) are organized into eighteen peer sets (including primary members P1 through P18 and secondary members S1 through S18) that are distributed among the first primary cluster device 204, the second primary cluster device 205, and the third primary cluster device 206. Although eighteen peer sets are distributed among the devices of the primary cluster 104 in FIG. 2, any number of peer sets may be distributed among any number of computing devices within a primary cluster for different applications in accordance with different embodiments. As shown in FIG. 2, the primary peer set members and secondary peer set members may be evenly or at least approximately evenly distributed among the computing devices of the cluster. Each peer set contributes file system storage to the overall cluster file system.

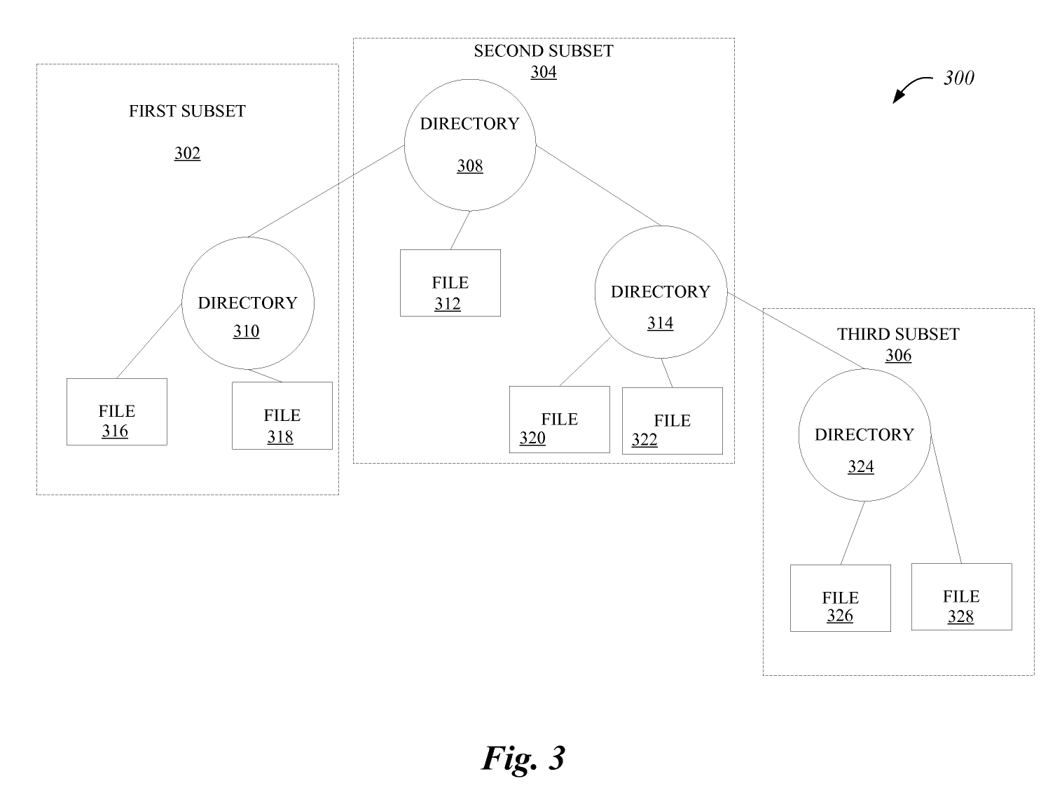

FIG. 3 is a conceptual diagram illustrating generally how the file system may be organized in the primary cluster of FIG. 2. The primary file data 300 may be organized in a file system format that includes the usual hierarchical arrangement of directories and files. The primary file data 300 in the file system format may be accessed by specifying a path from the directory to a particular file. For example, the file 326 is uniquely determined by the path from directory 308 to directory 314 to directory 324 to file 326.

A “subset” of the primary file data 300 as used herein includes a particular portion of the hierarchical file system organization, including that portion's associated directories and files. For example, a first subset 302 may include directory 310, file 316 and file 318. A second subset 304 may include directory 308, directory 314, file 312, file 320, and file 322. A third subset 306 may include directory 324, file 326 and file 328. Thereby, the primary file data 300 may be reproduced when the first subset 302, second subset 304, and third subset 306 are combined. Although only three subsets are illustrated, the primary file data 300 may be divided into any number of subsets as appropriate for different applications in different embodiments.

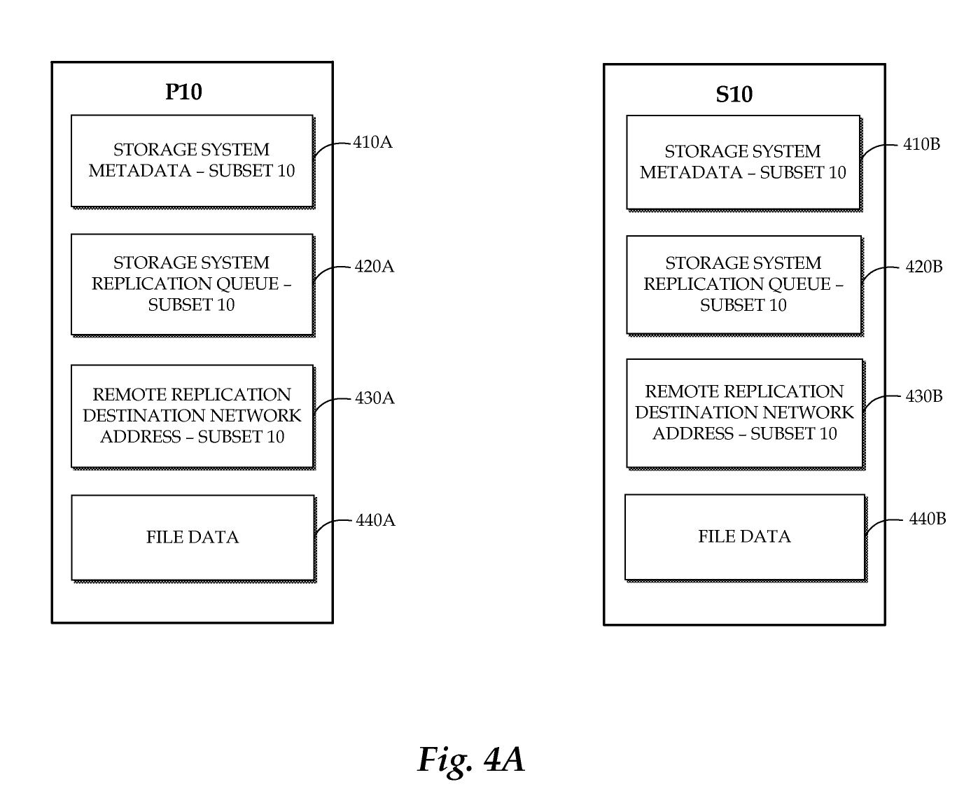

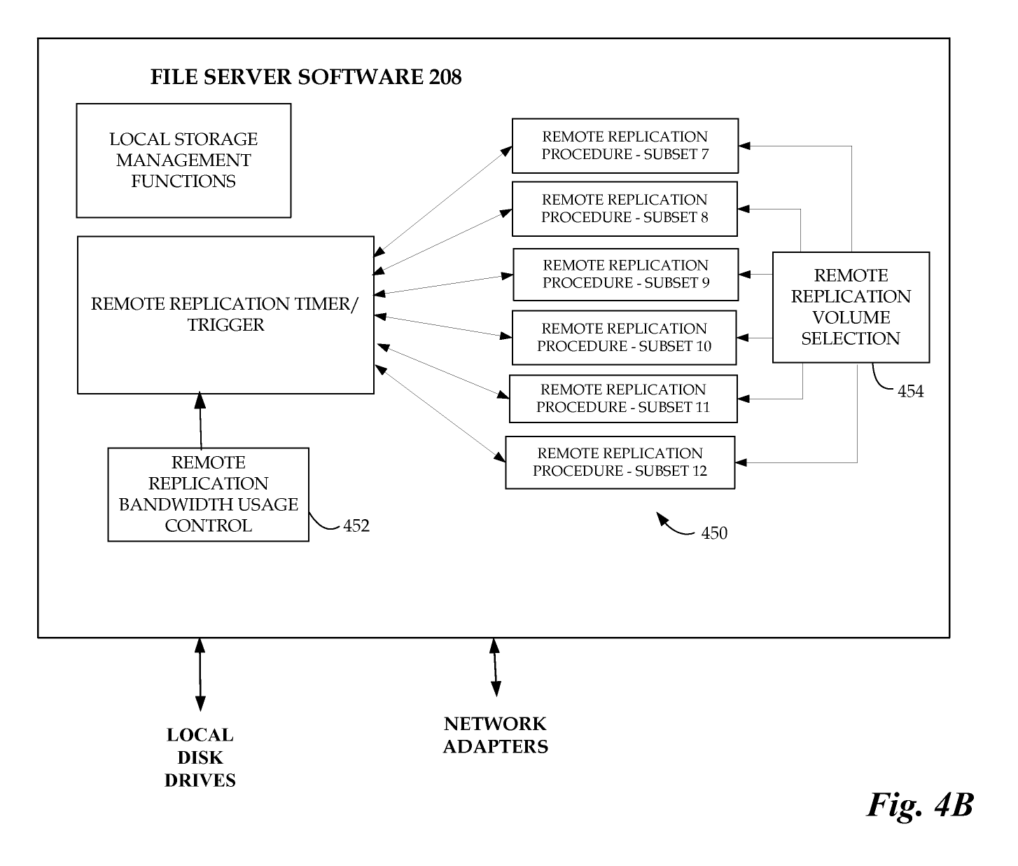

The file system of the primary cluster 104 is advantageously divided approximately evenly across the peer sets of the cluster such that each peer set hosts the metadata for a roughly equal portion of the total file system. In this example implementation, the metadata for each file and each directory in the cluster file system is hosted by exactly one peer set. The metadata hosted by each peer set is mirrored from the primary member onto all secondary members of the peer set. The actual file data for any given subset of the file system whose metadata is hosted exclusively by a corresponding peer set may be distributed across multiple other peer sets of the cluster. This effectively partitions the file system approximately equally across all the peer sets. Further discussion of peer sets and the above described partitioning of a file system between peer sets may be found in U.S. Pat. No. 8,296,398, entitled Peer-to-Peer Redundant File Server System and Methods, referred to and incorporated by reference above. This patent describes in detail many aspects of peer sets for data storage and delivery to clients in an enterprise environment. Further details regarding the use of peer sets in this implementation, especially as it relates to remote replication onto the secondary cluster 102 is provided further below with reference to FIGS. 4A, 4B, and 5.

Returning to the system illustrated in FIG. 2, in this implementation, each node 204, 205, and 206 of the primary cluster includes two network adapters (NICs). For example, the first primary cluster device 204 may include a NIC 240 for communications outside of the primary cluster and a NIC 244 for communications within the primary cluster. Also, the second primary cluster device 205 may have a NIC 241 for communications outside of the primary cluster and a NIC 245 for communications within the primary cluster. The third primary cluster device 206 may have a NIC 242 for communications outside of the primary cluster and a NIC 246 for communications within the primary cluster. The NICs 244, 245, and 246 may communicate with an internal switch/router 248 of the primary cluster. The NICs 240, 241, and 242 may communicate with an external switch/router 228. Thereby, the internal switch/router 248 may facilitate “back end network” communications between the computing devices 204, 205, 206 of the primary cluster for file access and storage functions within the primary cluster and for distributing data among the storage devices 202. The external switch/router 228 may facilitate “client network” communications between the primary cluster devices 204, 205, and 206, the client 108, and the secondary cluster 102. The NICs 240, 241, and 242 may be referred to herein as “forward facing.”

In the implementation illustrated in FIG. 2, the secondary storage system 102 is also implemented as a cluster of multiple computing devices. In the illustrated embodiment, the secondary cluster includes a first secondary cluster device 232, a second secondary cluster device 234, and a third secondary cluster device 236. Similar to the primary cluster 104, each of the computing devices 232, 334, 336 of the secondary cluster may include two NICs. The NICs 252, 256, and 262 may communicate with an internal switch/router 358 of the secondary cluster 102. The NICs 250, 254, and 260 may communicate with an external switch/router 238 of the secondary cluster. Thereby, the internal switch/router 258 may facilitate “back end” communications between nodes of the secondary cluster for file access and storage functions and for distributing data among the servers 232, 234, and 236 of the secondary cluster. Also, the external switch/router 327 may facilitate communications between the computing devices 232, 234, and 236 of the secondary cluster and the primary cluster 102 and the client 108. The NICs 250, 254, and 260 may be referred to herein as “forward facing.”

As introduced above, each of the peer sets of the primary cluster may be assigned to control access and monitor a particular subset of the primary file data 300 stored in the set of primary storage devices 220. More specifically, and referring now to FIG. 4A and the peer set 10 comprising primary member P10 and secondary member S10 in FIG. 2, the metadata for a particular subset of the files and directories of the file system (referred to as subset 10 for this peer set) is stored on storage device P10 as shown by block 410A of FIG. 4A, and is mirrored onto storage device S10, as shown by block 410B of FIG. 4A. The other seventeen peer sets similarly are responsible for the metadata for subsets 1 through 9 and 11 through 18 of the directories and files of the file system. Each file or directory is a member of only one subset, and therefore each directory and file has its metadata on one peer set only. The actual data associated with a particular peer set assigned subset of directories and files is not necessarily stored on the same peer set as the metadata, but will generally be spread among other peer sets as well. Thus, the file data 440A on storage device P10 will include data from files and directories of other subsets, which will also be mirrored to storage device S10 as illustrated by block 440B.

This partitioning of the full file system of the primary cluster 104 into file and directory subsets can be leveraged to replicate the primary file data from the primary cluster 104 to the secondary cluster 102 in a balanced high throughput manner. To accomplish this, the NICs 250, 254, and 260 of the secondary storage cluster may be assigned a network address (e.g. an IP address) by a system administrator when the secondary storage system is created. It may be noted that multiple NICs may be provided on the secondary storage system 102 to provide multiple forward facing network ports regardless of whether the secondary storage system 102 is implemented as a cluster or not. These network addresses are distributed among the primary members of each of the peer sets of the primary cluster 104 for use during replication. As one example for the embodiment of FIG. 2, the network address for the first secondary cluster node 232 via NIC 250 may be allocated to peer sets 1, 4, 7, 10, 13, and 16. The network address for the second secondary cluster node 234 via NIC 254 may be allocated to peer sets 2, 5, 8, 11, 14, and 17. The network address for the third secondary cluster node 336 via NIC 260 may be allocated to peer sets 3, 6, 9, 12, 15, and 18. In FIG. 4A, the destination network address for replication is illustrated as also being stored on the storage devices of the peer set at 430A and 430B, although this address and its association with a peer set could be stored elsewhere.

For replication from the primary cluster 104 to the secondary cluster 102, the file server software 207, 208, and 209 includes replication procedure routines that can be opened to push files and directories from the primary cluster 104 to the secondary cluster 102. FIG. 4B is a functional block diagram illustrating these components of the server 205 that contains the primary members of peer sets 7 through 12. The file server software 208 can run multiple replication procedure threads 450, one for each primary peer set member storage device that is installed in that server. Because each of these replication threads operates on a pre-defined separate portion of the file system, they can all run as parallel threads. As will be explained further below, part of the remote replication procedure for each subset may be to construct an rsync command for one or more files or directories in the subset. Furthermore, the destination addresses of the secondary cluster for the threads are distributed evenly or approximately evenly between the threads, so that the server 205 pushes replication data to all of the servers of the secondary cluster in parallel as well. For the system of FIG. 2, where a primary cluster of servers 104 is pushing replication data to a secondary cluster of servers 102, and where each server of the primary cluster 104 includes multiple primary members associated with different peer sets, each server of the primary cluster may communicate file and directory replication information to multiple secondary cluster servers in parallel. This creates a “mesh” of network connections between all of the nodes of the primary cluster 104 with all of the nodes of the secondary cluster 102. This reduces latencies in the replication process and improves throughput dramatically over a replication scheme that connects individual primary cluster devices to individual secondary cluster devices during replication.

There are generally two phases of a replication process. One is at the initial establishment of the secondary cluster, when an initial copy of all the data stored in the file system on the primary cluster 104 needs to be migrated to the secondary cluster 102. This process can be accomplished by first having the secondary cluster mount the file system of the primary cluster and open an rsync daemon to accept rsync replication requests from the primary cluster 104. The “rsync” software comprises an open source replication code that many replication systems use to mirror data on one computer to another computer. It is often used to synchronize files and directories between two different systems. If desired, secure tunnels such as SSH can be used to provide data security for rsync transfers. It is provided as a utility present in most Linux distributions. An rsync command specifies a source file or directory and a destination. The rsync utility provides several command options that determine which files or portions thereof within the specified source file or directory need to be sent to the receiving system to synchronize the source and the destination with respect to the specified source file or directlry. At the primary cluster, the file server software 207, 208, and 209 could open replication threads that each construct one or more rsync commands with the source or sources being the highest parent directories in each respective subset.

Because this may use a large amount of network bandwidth and slow client 108 interaction with the primary storage system 104, depending on how many parallel threads are running replication routines, an administrator accessible bandwidth usage control 452 may be provided. With this control, an administrator can regulate the amount of network bandwidth that is dedicated to replication data. This control may be based on a setting for the maximum amount of replication data transferred per second, and/or the number of parallel threads that the file server software will have open at any given time, and may be further configurable to change based on date or time of day, or a current client traffic metric. This may free up network bandwidth on the client network for normal enterprise network traffic during replication procedures. Another administrator accessible control that can be provided is a definition of individual volumes or directories that are to be included or excluded from the replication process, shown in FIG. 4B as block 454. This control can store the replication volumes as defined by the administrator, and control the replication procedure threads to run rsync commands only on desired directories and/or files.

After the initial replication, the primary file data (including the files and metadata in the file system format) may be continually replicated to the secondary cluster by communicating change information characterizing a change to the primary file data from the primary cluster 104 to the secondary cluster 102. The change information may be any information that may be used by the secondary cluster 102 to replicate a change to the primary file data in the secondary file data maintained by the secondary cluster 102. For example, the change information may be the changed primary file data. The changed primary file data may be used to replace the unchanged secondary file data maintained by the secondary cluster, thereby replicating the change to the primary cluster.

The identification of changed or potentially changed files and/or directories of the primary file system for a given subset may be determined using the metadata for each subset of the file system stored on the primary member of each peer set assigned to each subset. The metadata stored on each primary member of each peer set contains information regarding times of creation, access, modification, and deletion for the files and directories in its subset of the file system. The file server software 207, 208, 209 accesses this metadata to create and store a replication queue 420A and 420B for each subset of the file system, each replication queue comprising a list of files and/or directories that identify those portions of each assigned subset that have been created, deleted, modified or potentially modified since the secondary cluster was last updated with such changes or since the secondary cluster was initialized. Periodically, and/or upon a triggering event, the file server software opens a replication thread for each file system subset to initiate a transfer of the change information (e.g. the changed file data) using as its destination for the changed files/directories the IP address assigned to each peer set. The transfer may be initiated by opening a thread to check if there are any changes in a replication queue for a given file system subset. The file server software may then coalesce all items in the list that belong to the same directory and execute a replication routine (e.g. an rsync command) using its assigned IP address as the target for one or more changed directories. After executing the replication routine, the file server software removes the replicated file data from the replication queue. As noted above, the change information may be determined and communicated using an rsync utility that sends the change information to the secondary cluster to synchronize the secondary file data in the secondary cluster with the primary file data in the primary cluster.

Thereby, the change information may be communicated from different primary peer set members hosted by a particular node of the primary cluster to different secondary cluster nodes. For example, the first primary cluster node 204 may communicate change information in parallel to all three of the first secondary cluster node 232, second secondary cluster node 234, and the third secondary cluster node 236. This is due to the first primary cluster node 204 hosting the primary peer set members P1 and P4 (assigned to the first secondary cluster node 232), the primary peer set members P2 and P5 (assigned to the second secondary cluster node 234), and theprimary peer set members P3 and P6 (assigned to the third primary peer set node 236). Also, the second primary cluster node 205 may communicate change information in parallel to all three of the first secondary cluster node 232, second secondary cluster node 234, and the third secondary cluster node 236. This is due to the second primary cluster node hosting the primary peer set members P7 and P10 (assigned to the first secondary cluster node 232), the primary peer set members P8 and P11 (assigned to the second secondary cluster node 234), and the primary peer set members P9 and P12 (assigned to the third primary peer set node 236). Furthermore, the third primary cluster node 206 may communicate change information in parallel to all three of the first secondary cluster node 232, second secondary cluster node 234, and the third secondary cluster node 236. This is due to the third primary cluster node hosting the primary peer set members P13 and P16 (assigned to the first secondary cluster node 232), the primary peer set members P14 and P17 (assigned to the second secondary cluster node 234), and the primary peer set members P15 and P18 (assigned to the third primary peer set node 236). Although in the above description the secondary storage system network address assignments to the different subsets of the primary file system are fixed, this need not be the case. The secondary storage system network address assignment for one or more of the subsets can rotate round robin through the available secondary storage system network addresses, or may be changed over time in other manners.

FIG. 5 is a flow chart of a process 500 for asynchronous data replication. The process may start at block 502. At block 502, at the primary storage system, the file system metadata is analyzed for different subsets of the primary file system to determine changed and/or potentially changed files and/or directories for each subset. At block 504, change information is communicated from the primary storage system for a plurality of the subsets to a secondary storage system in parallel to a plurality of network addresses assigned to network ports of the secondary storage system. At block 506, the process ends. Although the process is shown terminating at 506 in FIG. 5, it will be appreciated that the process will typically continually repeat to capture newly changed files and directories at the primary storage system and mirror those changes at the secondary storage system.

As described above, it is advantageous if both the primary storage system and the secondary storage system each have a plurality of forward facing network ports. In such implementations, different network ports of each storage system are used for traffic containing change information for different subsets of the primary file system. In some implementations, as shown in FIG. 2, one or both of the primary and secondary storage systems can be implemented as a cluster of computing devices. The mesh of network connections for replication traffic can be distributed over all network ports on both sides by assigning the replication traffic for each subset of the primary file system to one outgoing network port on the primary storage system and one network port on the secondary storage system. When the primary storage system is load balanced with respect to client traffic on the primary storage system, this helps produce load balancing between the branches of the mesh of replication network connections during the replication process.

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, choosing, establishing and the like. Further, a “channel width” as used herein may encompass or may also be referred to as a bandwidth in certain aspects.

As used herein, a phrase referring to “at least one of” a list of items refers to any combination of those items, including single members. As an example, “at least one of: a, b, or c” is intended to cover: a, b, c, a-b, a-c, b-c, and a-b-c.

The various operations of methods described above may be performed by any suitable means capable of performing the operations, such as various hardware and/or software component(s), circuits, and/or module(s). Generally, any operations illustrated in the Figures may be performed by corresponding functional means capable of performing the operations.

As used herein, the term interface may refer to hardware or software configured to connect two or more devices together. For example, an interface may be a part of a processor or a bus and may be configured to allow communication of information or data between the devices. The interface may be integrated into a chip or other device. For example, in some embodiments, an interface may comprise a receiver configured to receive information or communications from a device at another device. The interface (e.g., of a processor or a bus) may receive information or data processed by a front end or another device or may process information received. In some embodiments, an interface may comprise a transmitter configured to transmit or communicate information or data to another device. Thus, the interface may transmit information or data or may prepare information or data for outputting for transmission (e.g., via a bus).

The various illustrative logical blocks, modules and circuits described in connection with the present disclosure may be implemented or performed with a general purpose processor, a digital signal processor (DSP), an application specific integrated circuit (ASIC), a field programmable gate array signal (FPGA) or other programmable logic device (PLD), discrete gate or transistor logic, discrete hardware components or any combination thereof designed to perform the functions described herein. A general purpose processor may be a microprocessor, but in the alternative, the processor may be any commercially available processor, controller, microcontroller or state machine. A processor may also be implemented as a combination of computing devices, e.g., a combination of a DSP and a microprocessor, a plurality of microprocessors, one or more microprocessors in conjunction with a DSP core, or any other such configuration.

In one or more aspects, the functions described may be implemented in hardware, software, firmware, or any combination thereof. If implemented in software, the functions may be stored on or transmitted over as one or more instructions or code on a computer-readable medium. Computer-readable media includes both computer storage media and communication media including any medium that facilitates transfer of a computer program from one place to another. A storage media may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk and Blu-ray disc where disks usually reproduce data magnetically, while discs reproduce data optically with lasers. Thus, in some aspects computer readable medium may comprise non-transitory computer readable medium (e.g., tangible media). In addition, in some aspects computer readable medium may comprise transitory computer readable medium (e.g., a signal). Combinations of the above should also be included within the scope of computer-readable media.

The methods disclosed herein comprise one or more steps or actions for achieving the described method. The method steps and/or actions may be interchanged with one another without departing from the scope of the claims. In other words, unless a specific order of steps or actions is specified, the order and/or use of specific steps and/or actions may be modified without departing from the scope of the claims.

The functions described may be implemented in hardware, software, firmware or any combination thereof. If implemented in software, the functions may be stored as one or more instructions on a computer-readable medium. A storage media may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Disk and disc, as used herein, include compact disc (CD), laser disc, optical disc, digital versatile disc (DVD), floppy disk, and Blu-ray® disc where disks usually reproduce data magnetically, while discs reproduce data optically with lasers.

Thus, certain aspects may comprise a computer program product for performing the operations presented herein. For example, such a computer program product may comprise a computer readable medium having instructions stored (and/or encoded) thereon, the instructions being executable by one or more processors to perform the operations described herein. For certain aspects, the computer program product may include packaging material.

Software or instructions may also be transmitted over a transmission medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of transmission medium.

Further, it should be appreciated that modules and/or other appropriate means for performing the methods and techniques described herein can be downloaded and/or otherwise obtained by a user terminal and/or base station as applicable. For example, such a device can be coupled to a server to facilitate the transfer of means for performing the methods described herein. Alternatively, various methods described herein can be provided via storage means (e.g., RAM, ROM, a physical storage medium such as a compact disc (CD) or floppy disk, etc.), such that a user terminal and/or base station can obtain the various methods upon coupling or providing the storage means to the device. Moreover, any other suitable technique for providing the methods and techniques described herein to a device can be utilized.

It is to be understood that the claims are not limited to the precise configuration and components illustrated above. Various modifications, changes and variations may be made in the arrangement, operation and details of the methods and apparatus described above without departing from the scope of the claims.

While the foregoing is directed to aspects of the present disclosure, other and further aspects of the disclosure may be devised without departing from the basic scope thereof, and the scope thereof is determined by the claims that follow.

What is claimed is:

1. A method of replicating data from a primary storage system to a secondary storage system comprising:
at the primary storage system, analyze file system metadata for different subsets of the primary file system to determine changed and/or potentially changed files and/or directories for each subset;
communicate change information from the primary storage system for a plurality of the subsets to a secondary storage system in parallel to a plurality of network addresses assigned to network ports of the secondary storage system.

2. The method of claim 1, comprising assigning a network address of the plurality of network addresses to each of the different subsets of the primary file system.

3. The method of claim 2, comprising using different network ports of the primary storage system to communicate change information for different subsets of the primary file system.

4. A primary storage system, comprising:
a set of primary cluster devices storing primary file data comprising a first subset of the primary file data and a second subset of the primary file data, the first subset different than the second subset;
a first primary peer set member of a first peer set, the first primary peer set member hosted by a first primary cluster device, the first peer set comprising the first primary peer set member and a first secondary peer set member hosted by a second primary cluster device different than the first primary cluster device, the first primary peer set member configured to:
determine first subset change information characterizing a change to the first subset,
communicate the first subset change information to a first network address of a secondary storage system, the secondary storage system storing secondary file data that is a replication of the primary file data; and
a second primary peer set member of a second peer set, the second primary peer set member hosted by the first primary cluster device, the second peer set comprising the second primary peer set member and a second secondary peer set member hosted by the second primary cluster device, the second primary peer set member configured to:
determine second subset change information characterizing a change to the second subset, and
communicate the second subset change information to a second network address of the secondary storage system.

5. The system of claim 4, wherein the first subset change information is communicated to a first secondary cluster node by sending the first subset change information to a network address associated with the first secondary cluster node.

6. The system of claim 5, wherein the first subset change information is communicated using an rsync utility.

7. The system of claim 4, wherein the first subset change information is a portion of the first subset that has changed.

8. The system of claim 5, wherein the second subset change information is communicated to a second secondary cluster node by sending the second subset change information to a network address identifying the second secondary cluster node.

9. The system of claim 8, wherein the second subset change information is communicated using an rsync utility.

10. The system of claim 4, wherein the second subset change information is a portion of the second subset that has changed.

11. The system of claim 8, wherein the first secondary cluster node is different than the second secondary cluster node.

12. A method, comprising:
determining, using a primary cluster node, first change information for a first subset of primary file data;
determining, using the primary cluster node, second change information for a second subset of the primary file data;
communicating the first change information from the primary cluster node to a first secondary storage system network address; and
communicating the second change information from the primary cluster node to a second secondary storage system network address in parallel with communicating the first change information from the primary cluster node to the first secondary storage system network address.

13. A method, comprising:
determining first subset change information characterizing a change to a first subset of primary file data using a first primary peer set member of a first peer set, the first primary peer set member hosted by a first primary cluster node of a primary cluster, the primary cluster comprising the first primary cluster node and a second primary cluster node different than the first primary cluster node, the first peer set comprising the first primary peer set member and a first secondary peer set member hosted by the second primary cluster node, the primary file data comprising the first subset and a second subset different than the first subset;
determining second subset change information characterizing a change to a second subset using a second primary peer set member of a second peer set, the second primary peer set member hosted by the first primary cluster node, the second peer set comprising the second primary peer set member and a second secondary peer set member hosted by the second primary cluster node;
communicating the first subset change information to a first secondary cluster node of a secondary cluster, the secondary cluster comprising the first secondary cluster node and a second secondary cluster node different than the first secondary cluster node, the secondary cluster storing secondary file data that is a replication of the primary file data; and
communicating the second subset change information to the second secondary cluster node.

14. A data storage system comprising:
a primary storage system storing file data organized in a primary file system, the primary storage system comprising a first plurality of network ports;
a secondary storage system comprising a second plurality of network ports;
a mesh of network connections between the first plurality of network ports and the second plurality of network ports; wherein different branches of the mesh carry replication data traffic associated with file and directory data for different selected subsets of the primary file system.

15. The data storage system of claim 14, wherein replication data traffic for different subsets of the primary file system are assigned to different ones of the first plurality of network ports and different ones of the second plurality of network ports.

16. The data storage system of claim 14, wherein the primary storage system comprises a cluster of computing devices, wherein each computing device of the cluster comprises at least one of the first plurality of network ports.

17. The data storage system of claim 16, wherein the secondary storage system comprises a cluster of computing devices, wherein each computing device of the cluster comprises at least one of the second plurality of network ports.
